(19) United States
(12) Patent Application Publication
(10) Pub. No.: US 2025/0247794 A1
(43) Pub. Date: Jul. 31, 2025

(54) Reliable TCP Data Transfer Using Target Wake Time (TWT)

(71) Applicant: Silicon Laboratories Inc., Austin, TX (US)

(72) Inventors: Rahul Kumar Gurram, Hyderabad (IN); Atul Suresh Joshi, Pune (IN); Satish Nallamalla, Hyderabad (IN); Venkatesh Vinjamuri, Andhra Pradesh (IN)

(21) Appl. No.: 18/427,433

(22) Filed: Jan. 30, 2024

(51) Int. Cl. H04W 52/02; H04W 84/12

(52) U.S. Cl. CPC H04W 52/0258; H04W 84/12

(57) ABSTRACT

Methods and Wi-Fi devices that utilize the target wake time (TWT) feature of the Wi-Fi specification along with delayed TCP acknowledgment are disclosed. When using TWT and delayed TCP acknowledgment, the low power Wi-Fi device checks to see if the size of the payload is less than a predetermined value. By checking the size of the payload, the low power Wi-Fi device can quickly determine whether the received packet may be related to TCP connection/Application protocol connection maintenance. Based on this determination, if necessary, the low power Wi-Fi device can transmit an acknowledgment during the same TWT service period, thereby minimizing the chance that the TCP connection will be terminated.

### FIELD

This disclosure describes a system and various methods to implement TWT (Target Wake Time) and delayed TCP (Transmission Control Protocol) acknowledgments with a low power Wi-Fi device.

### BACKGROUND

The Wi-Fi protocol was originally designed to include devices which have access to unlimited power. Thus, early revisions of the specification did not include any provisions to support low power devices. But some devices, such as sensor devices, should ideally have a battery life that is more than one year, and need to enter a lower power mode in order to conserve battery life.

The Wi-Fi protocol was updated to include some power saving modes of operation. For example, one such update is the inclusion of PS-Poll. In this mode, the low power Wi-Fi device notifies the access point that it is entering a sleep mode. The access point will then buffer all outbound messages for this low power Wi-Fi device. If it has any outbound packets for this device, it indicates this in its beacon message. After waking, the low power Wi-Fi device checks the beacon and if there are stored messages, it transmits a packet to the access point requesting the stored packets.

A more recent update is the inclusion of Target Wake Time (TWT). This feature allows the low power Wi-Fi device to specify when it will be awake and for how long. When implemented, all data for the low power Wi-Fi device are transmitted during a predetermined interval referred to as the TWT service period. This is intended to allow longer periods of sleep mode and also reduce contention by allotting specific intervals for transmissions to each low power Wi-Fi device.

FIG. 1 shows the timing associated with target wake times. This figure shows two types of devices, an access point (or AP) and a device, also referred to as a station (STA). A schedule is negotiated between the access point and station. There are several parameters associated with this feature. These parameters include the TWT wake interval and the TWT wake duration. The TWT wake interval defines the frequency at which the station will awake. The TWT wake duration defines the period of time that the station is awake during each TWT wake interval. This awake time is known as TWT service period. Note that the station may be in low power mode (doze) during the period between completion of the TWT service period and the start of the next TWT service period. Note that the station does not need to remain awake for the entire TWT service period. For example, the access point may transmit an “end of service period” (EOSP) message, which indicates that there is no other data for the station, and the station may enter its low power mode. Additionally, the access point may transmit packets to the station, where the last packet contains an indication that no additional data will be forthcoming. If either of these events occurs, the station may enter low power mode before the end of the negotiated TWT wake duration.

Note that the TWT feature may define several modes of operation, announced and unannounced. In unannounced operation, the access point assumes that the station is awake during each TWT service period and therefore will send packets to the station at this time. In the announced operation, the station must first transmit a packet to the access point indicating that it is awake before the access point can transmit any packets to the station.

In this way, the station may not wake up for every TWT service period.

While this feature allows devices in the Wi-Fi network to have a low power mode, there are complications associated with this feature that need to be addressed. For example, depending on the values of the TWT wake interval and TWT wake duration, the low power device may still be active a large percentage of the time.

Another complication is the use of delayed acknowledgment with TWT. Delayed TCP acknowledgment is a mechanism whereby a receiver may delay returning an acknowledgment of a TCP packet for up to 200 milliseconds, although other delays are also possible. This is used to optimize bandwidth, as the expectation is that another TCP packet will arrive and the delayed TCP acknowledgment can be transmitted in the response to the later TCP packet. However, large TWT wake intervals may be problematic, especially in the case of “keep alive” messages.

Therefore, it would be beneficial if there was a system and method that allows low power Wi-Fi devices to utilize the Target Wake Time feature and the delayed TCP acknowledgment feature.

### SUMMARY

Methods and Wi-Fi devices that utilize the target wake time (TWT) feature of the Wi-Fi specification along with delayed TCP acknowledgment are disclosed. When using TWT and delayed TCP acknowledgment, the low power Wi-Fi device checks to see if the size of the payload is less than a predetermined value. By checking the size of the payload, the low power Wi-Fi device can quickly determine whether the received packet may be related to TCP connection/Application protocol connection maintenance. Based on this determination, if necessary, the low power Wi-Fi device can transmit an acknowledgment during the same TWT service period, thereby minimizing the chance that the TCP connection will be terminated.

According to one embodiment, a method of operating a low power Wi-Fi device using target wake time (TWT) is disclosed. The method comprises receiving an incoming TCP (Transmission Control Protocol) packet during a first TWT service period; determining a number of bytes in a payload of the TCP packet; transmitting a TCP acknowledgment during the first TWT service period if the number of bytes is greater than a first predetermined value or less than a second predetermined value; and delaying transmission of the TCP acknowledgment if the number of bytes is more than the second predetermined value and less than the first predetermined value. In some embodiments, the TCP acknowledgment is transmitted within 20 milliseconds of receipt of the incoming TCP packet if the number of bytes is greater than the first predetermined value or less than the second predetermined value. In some embodiments, the second predetermined value is a number indicative of a “keep alive” packet. In certain embodiments, the “keep alive” packet is associated with maintenance of a TCP connection or an application protocol connection. In certain embodiments, the second predetermined value is 90 bytes or less. In some embodiments, delaying transmission of the TCP acknowledgment comprises transmitting the TCP acknowledgment at least 100 milliseconds after receipt of the incoming TCP packet. In some embodiments, delaying transmission of the TCP acknowledgment comprises transmitting the TCP acknowledgment after additional incoming packets have been received. In some embodiments, delaying transmission of the TCP acknowledgment comprises transmitting the TCP acknowledgment during a second TWT service period, which occurs after the first TWT service period. In some embodiments, the first predetermined value is equal to a maximum segment size (MSS).

According to another embodiment, a low power Wi-Fi device is disclosed. The low power Wi-Fi device comprises a Wi-Fi network interface; a processing unit; and a memory device in communication with the processing unit comprising instructions, which when executed by the processing unit, enable the low power Wi-Fi device to: receive an incoming TCP packet during a first Target Wake Time (TWT) service period; determine a number of bytes in a payload of the TCP packet; transmit a TCP acknowledgment during the first TWT service period if the number of bytes is greater than a first predetermined value or less than a second predetermined value; and delay transmission of the TCP acknowledgment if the number of bytes is more than the second predetermined value and less than the first predetermined value. In some embodiments, the low power Wi-Fi device comprises instructions, which when executed by the processing unit, enable the low power Wi-Fi device to: transmit the TCP acknowledgment within 20 milliseconds of receipt of the incoming TCP packet if the number of bytes is greater than the first predetermined value or less than the second predetermined value. In some embodiments, the second predetermined value is a number indicative of a “keep alive” packet. In certain embodiments, the “keep alive” packet is associated with maintenance of a TCP connection or an application protocol connection. In certain embodiments, the second predetermined value is 90 bytes or less. In some embodiments, the first predetermined value is equal to a maximum segment size (MSS). In some embodiments, the low power Wi-Fi device comprises instructions, which when executed by the processing unit, enable the low power Wi-Fi device to: transmit the TCP acknowledgment during a second TWT service period, which occurs after the first TWT service period if the number of bytes is more than the second predetermined value and less than the first predetermined value. In some embodiments, the low power Wi-Fi device comprises instructions, which when executed by the processing unit, enable the low power Wi-Fi device to: transmit the TCP acknowledgment at least 100 milliseconds after receipt of the incoming TCP packet if the number of bytes is more than the second predetermined value and less than the first predetermined value. In some embodiments, the low power Wi-Fi device comprises instructions, which when executed by the processing unit, enable the low power Wi-Fi device to: transmit the TCP acknowledgment after additional incoming packets have been received if the number of bytes is more than the second predetermined value and less than the first predetermined value.

### BRIEF DESCRIPTION OF THE DRAWINGS

For a better understanding of the present disclosure, reference is made to the accompanying drawings, in which like elements are referenced with like numerals, and in which:

FIG. 1 shows a timing diagram showing the operation of the target wake time (TWT) feature with the Station in low power mode;

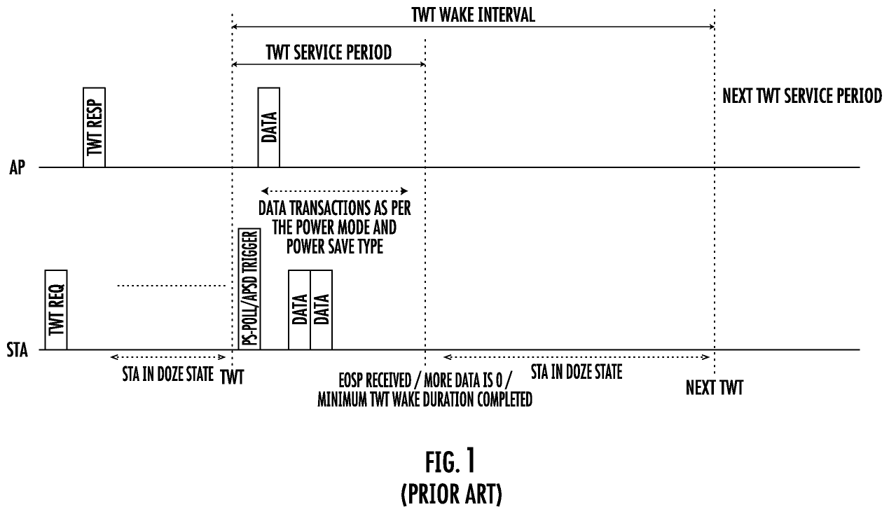

FIG. 2 shows a block diagram of a Wi-Fi network device;

FIG. 3 shows a system that includes a Wi-Fi network;

FIGS. 4A-4C show timing diagrams showing beacons and TWT service periods;

FIG. 5 is a timing diagram showing an issue with using TWT with delayed TCP acknowledgments;

FIG. 6 is a timing diagram that corrects the issue with using TWT with delayed TCP acknowledgments; and

FIG. 7 shows a flowchart detailing the operation of the low power Wi-Fi device using the concepts described herein.

### DETAILED DESCRIPTION

This disclosure presents a system and method that describes enhancements that allow improved operation of a network when using delayed TCP acknowledgment and the TWT feature. This is achieved by generating an immediate TCP acknowledgment in certain situations.

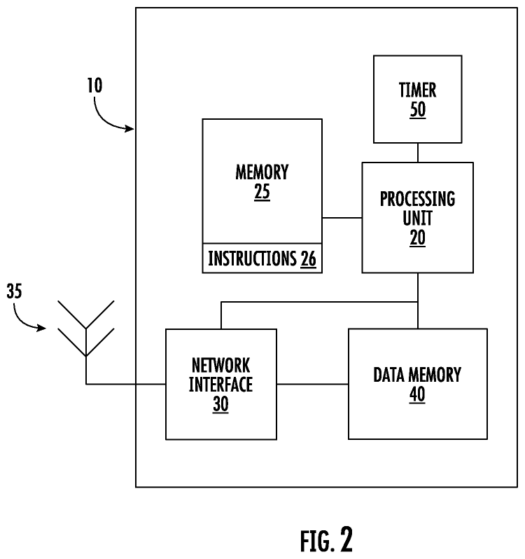

FIG. 2 shows a block diagram of a representative Wi-Fi device 10 that may be used to implement the disclosed method of minimizing power consumption in a Wi-Fi network.

The Wi-Fi device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Wi-Fi device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 2. The second computer readable non-transitory media may be a CDROM, or a different memory device, which is located remote from the Wi-Fi device 10. The instructions contained on this second computer readable non-transitory media may be downloaded onto the memory device 25 to allow execution of the instructions by the Wi-Fi device 10.

The Wi-Fi device 10 also includes a Wi-Fi network interface 30 that connects with a Wi-Fi network 100 using an antenna 35.

The Wi-Fi device 10 may include a data memory device 40 in which data that is received and transmitted by the Wi-Fi network interface 30 is stored. This data memory device 40 is traditionally a volatile memory. The processing unit 20 has the ability to read and write the data memory device 40 so as to communicate with the other devices in the Wi-Fi network 100.

Additionally, the Wi-Fi device 10 may include a timer 50. The timer 50 may be used to measure time durations. Further, the timer 50 may be used to wake the processing unit 20 from its low power or sleep mode.

Although not shown, the Wi-Fi device 10 also has a power supply, which may be a battery or a connection to a permanent power source, such as a wall outlet.

While the processing unit 20, the memory device 25, the Wi-Fi network interface 30, the data memory device 40 and the timer 50 are shown in FIG. 2 as separate components, it is understood that some or all of these components may be integrated into a single electronic component. Rather, FIG. 2 is used to illustrate the functionality of the Wi-Fi device 10, not its physical configuration.

In the wake state, all of the components described above may be powered. In the low power mode, one or more of these components may be in a sleep mode or powered off.

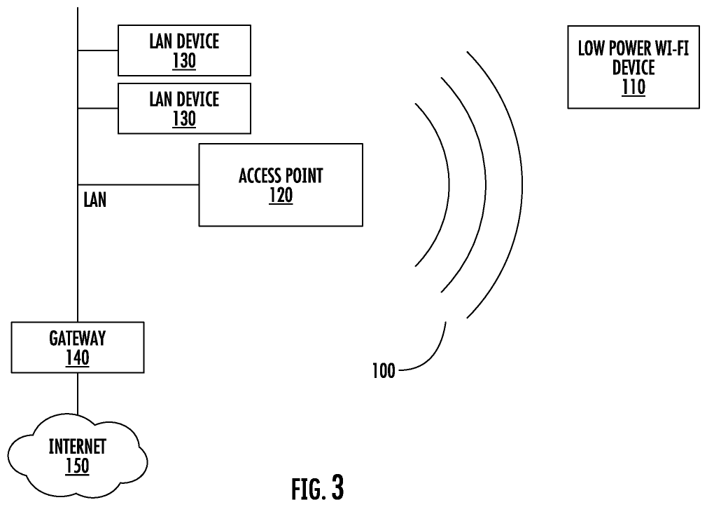

FIG. 3 shows a system that includes a Wi-Fi network 100. The Wi-Fi network 100 includes a low power Wi-Fi device 110 and access point 120, both of which may have an architecture similar to that shown in FIG. 2. In other words, both low power Wi-Fi device 110 and access point 120 are Wi-Fi network devices. The low power Wi-Fi device 110 may have a battery as a power source and may include a lower power processing unit and less memory capacity than the access point 120.

The access point 120 may also be in communication with a local area network (LAN). This LAN may be an Ethernet network, although other types of networks may be used. Also disposed on the LAN may be one or more LAN devices 130. These LAN devices 130 may include printers, personal computers, servers, and other devices. Additionally, a gateway 140 may be in communication with the LAN, and allow access to the internet 150.

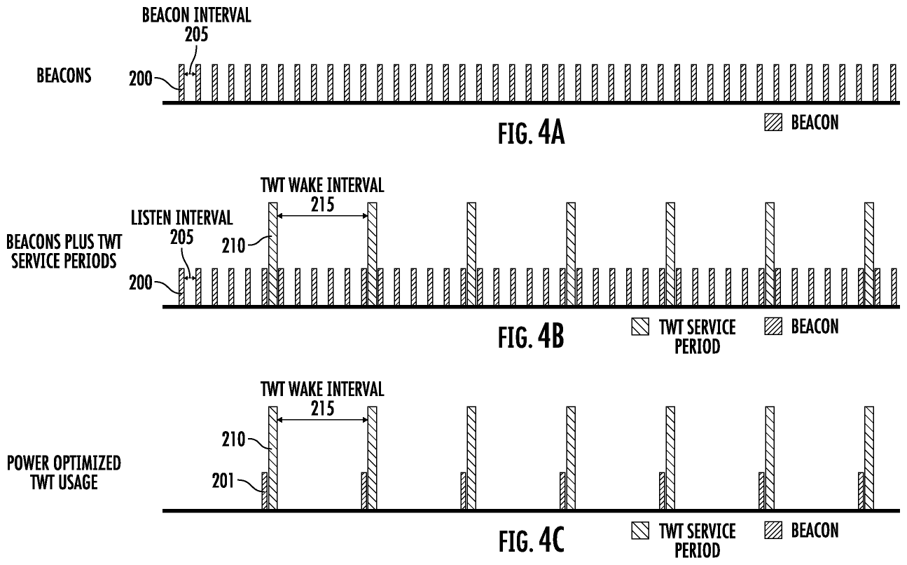

FIGS. 4A-4C show the use of TWT with the low power Wi-Fi device 110. As shown in FIG. 4A, the access point 120 transmits beacons 200. These beacons 200 are broadcast messages and may contain information that is relevant to the low power Wi-Fi device 110. These beacons 200 are transmitted periodically such that all devices in the Wi-Fi network 100 know when a beacon 200 will be transmitted. In some embodiments, the beacons 200 are transmitted every 100 milliseconds, which is referred to as a beacon interval 205. To conserve power, the low power Wi-Fi device 110 may only awaken for a fraction of these beacons 200. For example, the low power Wi-Fi device 110 may awaken for every N^{th} beacon, wherein N is greater than 1.

The timing diagram of FIG. 4B shows the TWT service periods 210 superimposed on the timing diagram of FIG. 4A. Note that in this figure, the TWT wake interval 215 is greater than the beacon interval 205. Specifically, in FIG. 4B, the TWT wake interval 215 is shown as being roughly equal to 6 beacon intervals 205. Further, in certain embodiments, the beacon 200 may contain an indication that the access point 120 has a packet or other information destined for the low power Wi-Fi device 110. This may be indicated in the Traffic Indication Map Information Element (TIM IE) of the beacon 200. The low power Wi-Fi device 110 may use this information to determine whether it should return to a wake state during the next TWT service period 210. However, as shown in FIG. 4B, even if the first beacon 200 contains this indication, the low power Wi-Fi device 110 is unable to receive this packet until its scheduled TWT service period 210. Therefore, there is no advantage to waking up for each beacon 200.

Thus, in one embodiment, shown in FIG. 4C, the low power Wi-Fi device 110 conserves power by only waking up for the beacon 200 that immediately precedes its TWT service period 210. This beacon may be referred to as the indicator beacon 201. Thus, in this embodiment, the low power Wi-Fi device 110 compares its TWT wake interval 215 to the beacon interval 205 and determines which beacons 200 occur immediately before each of its TWT service period 210. The low power Wi-Fi device 110 then only wakes for these indicator beacons 201. As a specific example, in FIG. 4C, the low power Wi-Fi device 110 determines that it should wake up every sixth beacon. Note that to be more efficient, the indicator beacon 201 should be the last beacon 200 that is received before the start of the TWT service period 210. However, in other embodiments, the low power Wi-Fi device 110 may utilize a different beacon as the indicator beacon 201. Note that this modification reduces the number of times that the low power Wi-Fi device 110 wakes up by a factor of 6. Note that if the TWT wake interval 215 is even longer, this power saving will be even larger.

Thus, in one embodiment, to save power, the low power Wi-Fi device 110 only wakes up for one beacon 200 during each TWT Wake interval 215, referred to as the indicator beacon 201. The processing unit 20 may use the TWT wake interval 215 and the beacon interval 205 to determine the value that may be stored in the timer 50 such that the low power Wi-Fi device 110 exits its low power mode once per TWT wake interval 215. As noted above, in some embodiments, the indicator beacon 201 is the last beacon transmitted before the start of the TWT service period 210. The processing unit 20 then parses the beacon 200 to determine if there is any pending data for this device. If there is not, the processing unit 20 returns to the sleep mode until the next indicator beacon 201. If there is data pending, the processing unit 20 configures the timer 50 such that it exits the low power mode during the next TWT service period 210. It then transmits a packet to the access point 120 to indicate that it is awake, and receives the packet from the access point 120.

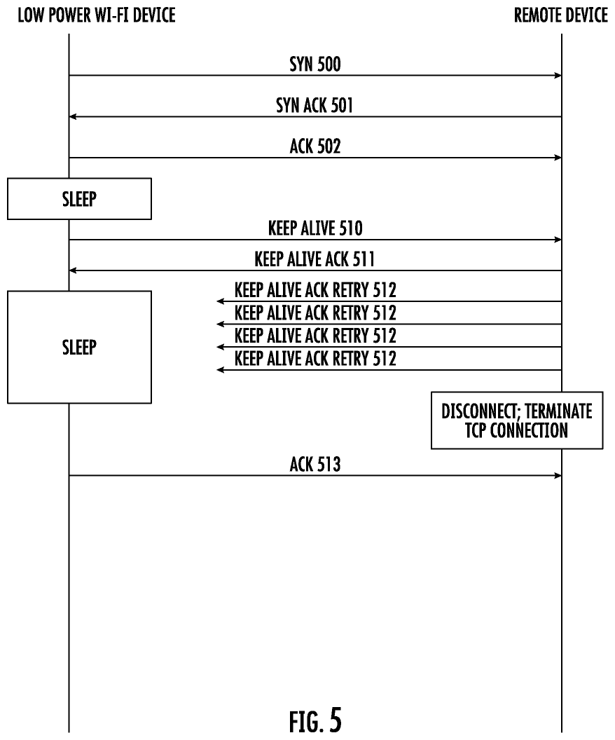

FIG. 5 is a timing diagram that shows the issue associated with using delayed TCP acknowledgment with TWT. Delayed TCP acknowledgment allows a device to wait up to a maximum duration (such as 200 milliseconds) before transmitting an acknowledgment for an earlier TCP packet. This allows the acknowledgment to possibly be transmitted with another packet that is being sent. In certain embodiments, the device may use the total received byte count to determine when to transmit an acknowledgment. For example, for large payloads, an acknowledgment may be sent immediately. For smaller payloads, the device may wait until the total number of bytes received since the last acknowledgment has reached a predetermined value.

In this diagram, it is assumed that the TWT wake interval 215 is several seconds, while the TWT service period 210 is 64 milliseconds.

In this diagram, the low power Wi-Fi device 110 initiates a TCP connection by sending a SYN packet 500 to a remote device, which may be LAN device 130. Note that, in certain configurations, one or more devices may be disposed between the remote device and the low power Wi-Fi device 110. For example, the remote device may be a LAN device 130 and an access point 120 may be disposed between the two nodes. In response, the remote device sends a SYN ACK packet 501. Finally, the low power Wi-Fi device 110 acknowledges the SYN ACK packet 501 with an ACK packet 502 and a TCP connection is formed.

At a later time, the low power Wi-Fi device 110 may transmit a “Keep Alive” message 510 to the remote device. In response, the remote device responds with a “Keep Alive” ACK 511. The low power Wi-Fi device 110 receives the “Keep Alive” ACK 511. Since the size of this packet is smaller than the predetermined value, the low power Wi-Fi device 110 determines that a delayed TCP acknowledgment may be used. Since the delay associated with a delayed TCP acknowledgment (which may be greater than 100 milliseconds, such as 200 milliseconds) is greater than the TWT Service Period 210, the low power Wi-Fi device 110 then enters sleep mode before transmitting the acknowledgment. As noted above, the TWT Wake interval 215 may be several seconds. Therefore, the low power Wi-Fi device 110 will not be able to transmit the ACK for the “Keep Alive” ACK 511 in the specified time. In response, the remote device may transmit one or more retries 512 to the low power Wi-Fi device 110, which are not received by the low power Wi-Fi device 110 since it is in sleep mode. Consequently, the remote device terminates the TCP connection. When the low power Wi-Fi device 110 wakes, it may then send the ACK 513, but this occurs after the connection has been terminated. Thus, the entire connection establishment procedure must be repeated. This lowers overall performance and requires increased power consumption by the low power Wi-Fi device 110.

There are approaches that may be used to address this issue. In one scenario, the TWT Wake interval 215 may be shortened to less than 200 milliseconds. In this way, if the low power Wi-Fi device 110 determines that delayed TCP acknowledgment is to be used, it is guaranteed that the acknowledgment is sent during the next TWT service period 210, which is within the prescribed time. Thus, the sleep period shown in FIG. 5 is shortened to be less than the time required to maintain the TCP connection. However, such an approach increases the power consumption of the low power Wi-Fi device 110, as it wakes more often.

Another approach would be to disable delayed TCP acknowledgments for packets that are associated with maintenance of the TCP connection. Note that while the disclosure discussed TCP connections, this technique applies to higher layer connections as well. For example, TCP refers to the transport layer protocol. However, application layer protocols, such as MQTT (Message Queueing Telemetry Transport), HTTP (hypertext transport protocol) and others may also include “keep alive” packets. Further, most packets that are associated with the TCP connection and/or the application protocol connection have small payloads, such as less than 90 bytes. For example, MQTT specifies a payload of 2 bytes for “keep alive” packets. MQTTS, which is a secure version of MQTT, specifies a payload for “keep alive” packets that may be as many as 85 bytes (2 bytes of payload, 14 bytes of padding to get a payload of at least 16 bytes, 32 or 64 bytes of hash data for integrity checking (depending on the algorithm selected for the cipher) and 5 bytes of SSL header. Other packets that include a zero payload or no data may also be referred to as “keep alive” packets.

Thus, in this embodiment, whenever the payload of the packet is 90 bytes or less, delayed TCP acknowledgment is disabled. Thus, a TCP acknowledgment must be transmitted immediately. In this disclosure, the term “immediately” when referring to the transmission of a TCP acknowledgment, is defined as within a short duration, such that the TCP acknowledgment is transmitted during the current TWT service period 210. This short duration may be less than 20 milliseconds. In this way, if the TWT service period 210 is 64 milliseconds, there is sufficient time for the low power Wi-Fi device 110 to receive the “keep alive” packet, parse the packet and deliver the TCP acknowledgment within the same TWT Service period 210.

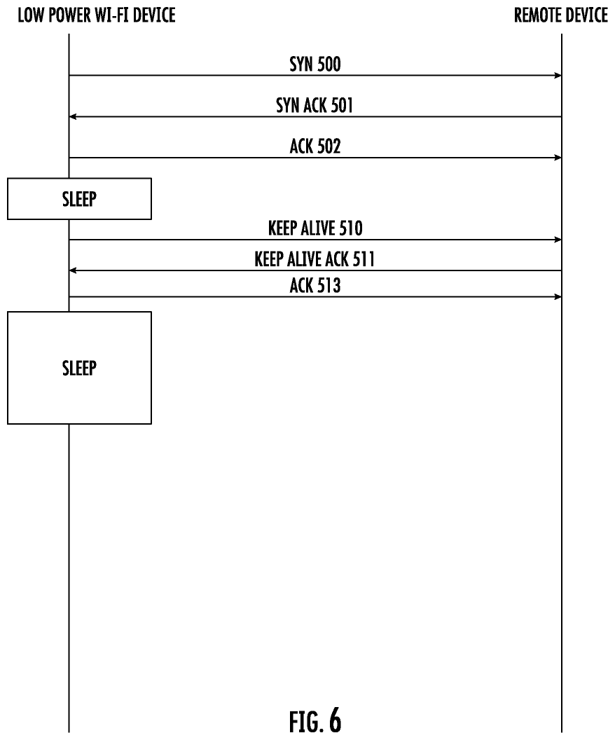

FIG. 6 shows a timing diagram similar to that shown in FIG. 5, however, in this scenario, the acknowledgment is transmitted by the low power Wi-Fi device during the same TWT service period in which the “Keep alive” ACK was received. In this way, the acknowledgment is sent before the next sleep period, and the TCP connection is maintained.

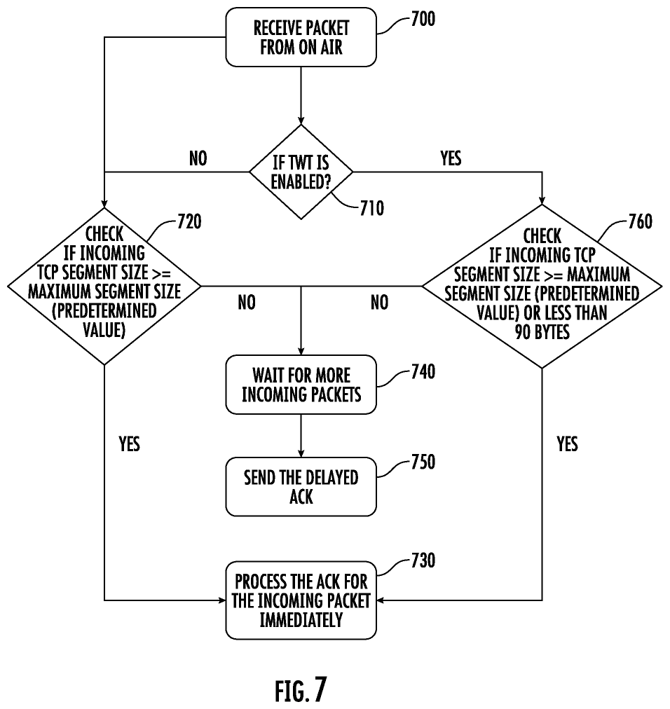

FIG. 7 shows a flowchart that may be used to implement this approach. First, as shown in Box 700, a packet is received wirelessly. Then, in Decision Box 710, the low power Wi-Fi device 110 checks if it is operating with TWT enabled. If TWT is not enabled, the low power Wi-Fi device 110 then checks the size of the payload, as shown in Decision Box 720. If the number of bytes in the payload of the packet is greater than or equal to a first predetermined value, the low power Wi-Fi device 110 moves to Box 730, where it transmits an acknowledgment immediately. This first predetermined value may be the maximum segment size, which in some embodiments is 1460 bytes or some other value. Alternatively, the first predetermined value may be a different number of bytes. If, however, the number of bytes in the payload of the packet is less than the first predetermined value, the low power Wi-Fi device 110 utilizes delayed TCP acknowledgment. Specifically, the low power Wi-Fi device 110 waits for additional packets to be received, as shown in Box 740. Once one or more additional packets have been received, a delayed TCP acknowledgment is transmitted, as shown in Box 750.

Returning to Decision Box 710, if TWT is enabled, the operation of the low power Wi-Fi device 110 is different. First, as shown in Decision Box 760, the low power Wi-Fi device 110 checks the size of the payload. If it is greater than or equal to the first predetermined value, it proceeds to transmit an acknowledgment immediately, as shown in Box 730 and explained above. Additionally, the low power Wi-Fi device 110 checks to see if the size of the payload is less than a second predetermined value. If it is, the low power Wi-Fi device 110 proceeds to Box 730. As explained above, this second predetermined value may be 90 bytes or less. In this way, all packets associated with maintaining the TCP connection are acknowledged immediately. If the number of bytes in the packet is more than the second predetermined value and less than the first predetermined value, the low power Wi-Fi device 110 waits for additional packets to be received, as shown in Box 740. Once one or more additional packets have been received, a delayed TCP acknowledgment is transmitted, as shown in Box 750.

This system and method has many advantages. As noted above, the Target Wake Time (TWT) feature has the potential to reduce power consumption for low power Wi-Fi devices. As explained above, TWT allows very low power operation of a Wi-Fi device, as the amount of time that the device is active is small and predictable. Additionally, delayed TCP acknowledgments may be used to improve bandwidth and utilization of the shared medium. However, use of both of these features simultaneously may lead to TCP connection terminations. The present disclosure describes an enhancement that enables delayed TCP acknowledgment to be used with TWT while minimizing the possibility of TCP connection terminations. By checking the size of the payload, the low power Wi-Fi device can quickly determine whether the received packet may be related to TCP connection maintenance or application protocol connection maintenance. Based on this determination, if necessary, the low power Wi-Fi device can transmit an acknowledgment during the same TWT service period, thereby minimizing the chance that the TCP (or application protocol) connection will be terminated. Note that even though other packets may have small payloads, the additional immediate acknowledgments do not significantly impact utilization or bandwidth.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of operating a low power Wi-Fi device using target wake time (TWT), comprising:
receiving an incoming TCP (Transmission Control Protocol) packet during a first TWT service period;
determining a number of bytes in a payload of the TCP packet;
transmitting a TCP acknowledgment during the first TWT service period if the number of bytes is greater than a first predetermined value or less than a second predetermined value; and
delaying transmission of the TCP acknowledgment if the number of bytes is more than the second predetermined value and less than the first predetermined value.

2. The method of claim 1, wherein the TCP acknowledgment is transmitted within 20 milliseconds of receipt of the incoming TCP packet if the number of bytes is greater than the first predetermined value or less than the second predetermined value.

3. The method of claim 1, wherein the second predetermined value is a number indicative of a “keep alive” packet.

4. The method of claim 3, wherein the “keep alive” packet is associated with maintenance of a TCP connection or an application protocol connection.

5. The method of claim 3, wherein the second predetermined value is 90 bytes or less.

6. The method of claim 1, wherein delaying transmission of the TCP acknowledgment comprises transmitting the TCP acknowledgment at least 100 milliseconds after receipt of the incoming TCP packet.

7. The method of claim 1, wherein delaying transmission of the TCP acknowledgment comprises transmitting the TCP acknowledgment after additional incoming packets have been received.

8. The method of claim 1, wherein delaying transmission of the TCP acknowledgment comprises transmitting the TCP acknowledgment during a second TWT service period, which occurs after the first TWT service period.

9. The method of claim 1, wherein the first predetermined value is equal to a maximum segment size (MSS).

10. A low power Wi-Fi device, comprising: a Wi-Fi network interface;
a processing unit; and
a memory device in communication with the processing unit comprising instructions, which when executed by the processing unit, enable the low power Wi-Fi device to:
receive an incoming TCP packet during a first Target Wake Time (TWT) service period;
determine a number of bytes in a payload of the TCP packet;
transmit a TCP acknowledgment during the first TWT service period if the number of bytes is greater than a first predetermined value or less than a second predetermined value; and
delay transmission of the TCP acknowledgment if the number of bytes is more than the second predetermined value and less than the first predetermined value.

11. The low power Wi-Fi device of claim 10, further comprising instructions, which when executed by the processing unit, enable the low power Wi-Fi device to: transmit the TCP acknowledgment within 20 milliseconds of receipt of the incoming TCP packet if the number of bytes is greater than the first predetermined value or less than the second predetermined value.

12. The low power Wi-Fi device of claim 10, wherein the second predetermined value is a number indicative of a “keep alive” packet.

13. The low power Wi-Fi device of claim 12, wherein the “keep alive” packet is associated with maintenance of a TCP connection or an application protocol connection.

14. The low power Wi-Fi device of claim 12, wherein the second predetermined value is 90 bytes or less.

15. The low power Wi-Fi device of claim 10, wherein the first predetermined value is equal to a maximum segment size (MSS).

16. The low power Wi-Fi device of claim 10, further comprising instructions, which when executed by the processing unit, enable the low power Wi-Fi device to: transmit the TCP acknowledgment during a second TWT service period, which occurs after the first TWT service period if the number of bytes is more than the second predetermined value and less than the first predetermined value.

17. The low power Wi-Fi device of claim 10, further comprising instructions, which when executed by the processing unit, enable the low power Wi-Fi device to: transmit the TCP acknowledgment at least 100 milliseconds after receipt of the incoming TCP packet if the number of bytes is more than the second predetermined value and less than the first predetermined value.

18. The low power Wi-Fi device of claim 10, further comprising instructions, which when executed by the processing unit, enable the low power Wi-Fi device to: transmit the TCP acknowledgment after additional incoming packets have been received if the number of bytes is more than the second predetermined value and less than the first predetermined value.
